(19) United States
(12) Patent Application Publication
(10) Pub. No.: US 2011/0074684 A1
(43) Pub. Date: Mar. 31, 2011

(54) DUST-PROOF COMPUTER MOUSE

(76) Inventors: Benjamin Abraham, Cupertino, CA (US); Robert Campesi, Cupertino, CA (US)

(21) Appl. No.: 12/993,576

(22) PCT Filed: Jul. 11, 2008
(86) PCT No.: PCT/US08/69735

§ 371 Date: Nov. 19, 2010

(51) Int. Cl. G06F 3/033

(52) U.S. Cl. 345/166

(57) ABSTRACT

A dust-proof computer mouse with scroll function is disclosed. The computer mouse contains a housing having an upper surface and a lower surface, at least one depressible button on the upper surface, a scrolling area on the upper surface, an optical sensor dimple on the lower surface, and a cover layer covering at least an area of the upper surface around the depressible button to prevent dust from entering the interior of the housing through spaces around the depressible button.

### TECHNICAL FIELD

The present invention generally relates to computer peripheral devices and, more particularly, to a sealed computer mouse for operation in a dusty environment.

### BACKGROUND

The computer mouse is one of the most frequently failing components in the typically dusty environments where many computers are. located. Dusty environments exist in many places in the world where dust storms occur frequently. Dusty environments also exist in many factories, such as factories that deal with wood, concrete manufacturing, medical pill production, paper production, or other similar operations. In a dusty environment, dust accumulates in the computer mouse, preventing button clicks. Dust may also accumulate on the outer surface of the computer mouse, clogging the space in front of the optical sensor on the mouse.

As shown in FIG. 1A, a full-featured computer mouse 100 typically includes a housing 10 that is small enough to be grasped and operated in a single hand. The housing 10 has a tipper surface 12 and a lower surface 14. The upper surface 12 is usually a curved surface with at least one, typically two, and sometimes more than two finger depressible selection buttons 20. The two buttons 20 shown in FIG. 1A, commonly referred to as the left button and the right button, allow a user to perform the “left click” and “right click” action, respectively, to send commands to the computer. The housing 10 may also contain a scroller 30 on the upper surface 12. The scroller 30 can be a scrolling wheel or a trackball that allows a user to move a pointer or a cursor on the computer screen.

As shown in FIG. 1B, the lower surface 14 of the housing 10 is a flat surface that allows the mouse 100 to be moved on top of a mouse pad or other flat supporting surface. A transparent sensor dimple 16 at the lower surface 14 allows an optical sensor inside the housing 10 to detect movement of the mouse 100 relative to the mouse pad or the flat supporting surface, and to convert the mouse movement to cursor movement on the computer screen. Inside the housing 10 are electronic circuits and components that process the motion and button information, and transmit the control signals to the computer. The housing 10 is typically assembled from two or more pieces of molded plastic material.

In a typical work environment, the depressible buttons 20 and scroller 30 on the upper surface 12 of the housing 10 are exposed to the environment. Because the buttons 20 and scroller 30 are separated from the non-movable portion of the housing 10 by spaces 11, dust may enter the housing 10 through the spaces 11. The dust accumulates in the mouse 100 and in the spaces between the buttons 20, preventing the button clicks. The dust also accumulates on the outer surface of the mouse 100, clogging the space in front of the optical sensor. The accumulated dust may also absorb moisture from the ambient air and form unwanted conductive paths that lead to short circuits and malfunction. Therefore, the computer mouse needs to be opened and cleaned periodically. The cleaning process exposes the electronic components to potential mechanical damage and/or electrostatic discharge (ESD) damage.

### SUMMARY

A dust-proof computer mouse with scroll function is disclosed. The computer mouse contains a housing having an upper surface and a lower surface, at least one depressible button on the upper surface, a scrolling area on the upper surface, an optical sensor dimple on the lower surface, and a cover layer. The housing and the depressible button define spaces around the depressible button. The cover layer covers, the spaces around the depressible button, therefore prevents dust from entering the interior of the housing through the spaces.

### BRIEF DESCRIPTION OF THE DRAWINGS

FIGS. 1A and 1B are top and bottom views, respectively, of a prior art computer mouse.

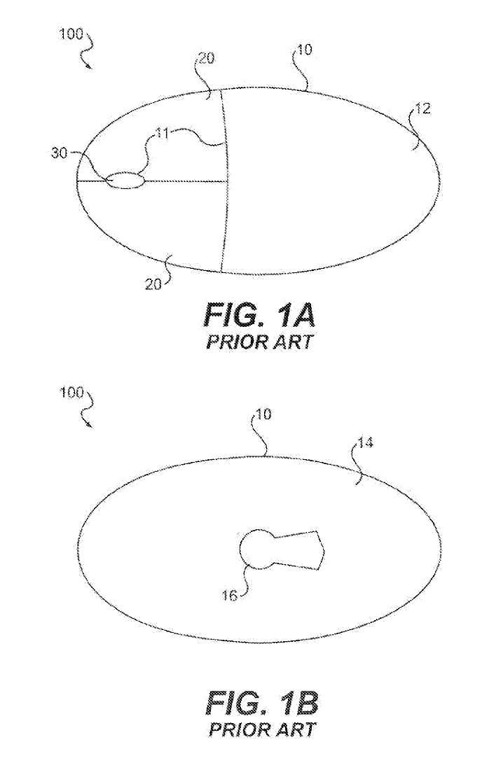

FIGS. 2A-2C are top, side and bottom views, respectively, of a dust-proof mouse.

FIGS. 3A and 3B are side and bottom views, respectively, of another embodiment of a dust-proof mouse.

FIG. 4 is a schematic showing another embodiment of a dust-proof mouse.

### DETAIL DESCRIPTION OF PREFERRED EMBODIMENT

This description is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “front,” “back,” “up,” “down,” “top” and “bottom,” as well as derivatives thereof, should he construed to refer to the orientation as then described or as shown in the drawing figure under discussion. These relative terms are for convenience of description and normally are not intended to require a particular orientation. Terms concerning attachments, coupling and the like, such as “connected” and “attached,” refer to a relationship wherein structures are secured or attached to one another either directly or indirectly through intervening structures, as well as both movable or rigid attachments or relationships, unless expressly described otherwise.

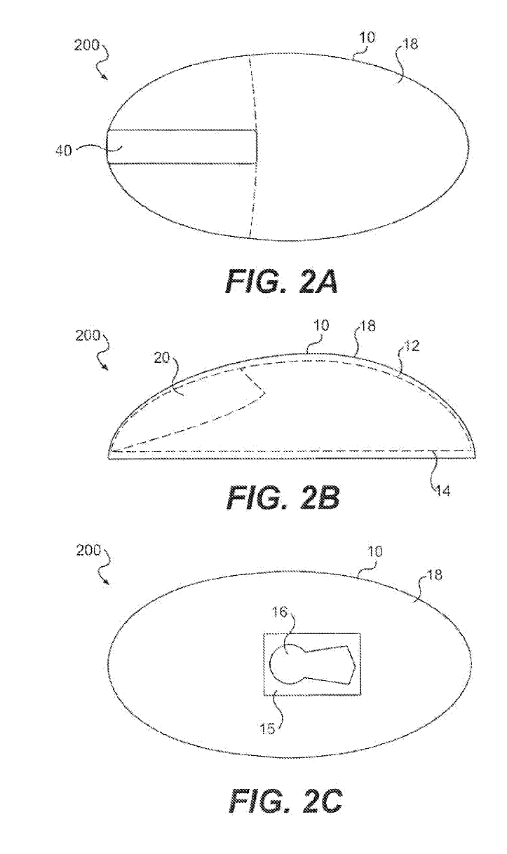

FIGS. 2A-2C depict a dust-proof mouse 200 that contains a housing 10 with a upper surface 12 and a lower surface 14, a scrolling area 40, and a cover layer 18. The upper surface 12 is a curved surface with at least one, typically two, and sometimes more than two finger depressible selection buttons 20. The lower surface 14 is a flat surface with a transparent sensor dimple 16. The cover layer 18 is a thin, elastic layer that wraps around the mouse 200 to prevent dust from entering the mouse 200 from spaces around the buttons 20. A user can click the buttons 20 through the cover layer 18. The scrolling area 40 serves the same function as the scroller 30 in the prior art computer mouse 100, i.e., allowing a user to move a pointer or a cursor on the computer screen. The scrolling area 40 can be, for example, a touchpad strip or an optical finger navigator.

Touchpads have been widely used in laptop computers and computer mice. A touchpads controls the movement of the cursor by detecting motions of a user's finger on the touchpad. Traditional touchpads operate in one of a few different ways, all of which entail sensing the capacitance of a finger, or the capacitance between sensors. A touchpad may be designed to sense the capacitance of finger even if it is covered with a thin layer of rubber or plastic (e.g., the cover layer. 18). The operation of such a touchpad, however, may not be ideal. New models of touchpads often have more functions because they are pressure-sensitive. Many new touchpads have the function of tapping, which imitates the left-click button on a mouse. The user can choose and change the function of certain finger movements. For example, the normal function for tapping on the touchpad is the left-click on the mouse. The user can change it in the settings section to the right-click of the mouse.

The optical finger navigator, on the other hand, utilizes a high quality image system to track the motion of a finger placed on a sensor pad. Motion is tracked and processed to create two dimensional direction vectors, which arc then used by the display system on the host to control the motion of an on screen cursor. The optical finger navigator will still be highly operable even if the sensor pad is covered with a thin layer of transparent material.

Referring now to FIG. 2A, the cover layer 18 is attached to all sides of the scrolling area 40 to form a dust-proof seal. In one embodiment, the cover layer 18 is glued around the touchpad strip or the optical finger navigator cover.

Alternatively, the cover layer 18 may cover the entire surface of mouse 200 including the scrolling area 40. If the scrolling area 40 contains a touchpad, the cover layer 18 may be a thin layer of elastic material that will not interfere with the operation of the touch pad. If the scrolling area 40 contains an optical finger navigator, the cover layer 18 may be a thin, transparent layer that allow for normal operation of the optical finger navigator. As shown in FIG. 2C, the cover layer 18 also covers the lower surface 14 of the mouse 200 with a transparent window 15 on top of the sensor dimple 16 to prevent dust from clogging in the sensor dimple 16.

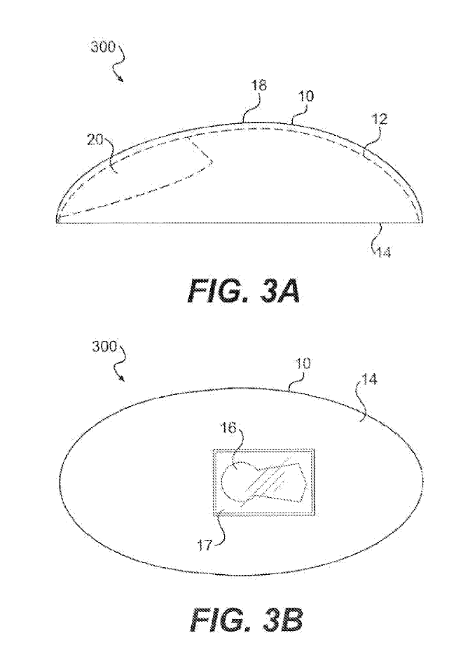

In another embodiment, only the upper surface 12 of the housing 10 is covered by the cover layer 18. As shown in FIG. 3A, the upper surface 12 of mouse 300 is covered by the cover layer 18 that forms a dust-proof seal around the scrolling area 40. The lower surface 14 of the housing 10 is not covered by the cover layer 18. The sensor dimple 16, however, is covered with a transparent window 17 that is flush with the lower surface 14 to prevent dust from clogging the sensor dimple 16 (FIG. 3B).

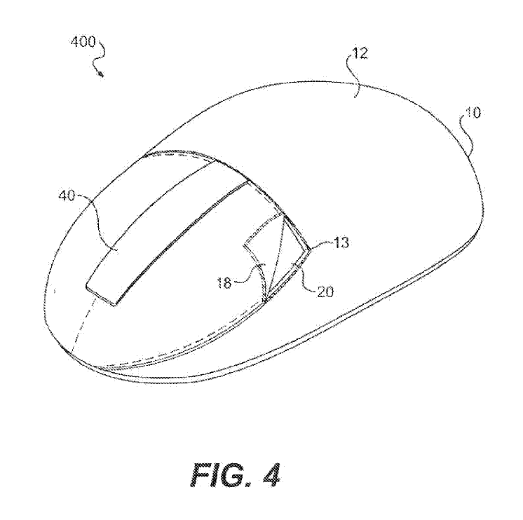

In yet another embodiment, only a portion of the upper surface 12 is covered by the cover layer 18. As shown in FIG. 4, the upper surface 12 of mouse 400 is molded with a recessed area 13 around the buttons 20. The cover layer 18 is attached to the recessed area 13 to form a dust-proof seal around the buttons 20. In this embodiment, the depth of the recessed area 13 matches the thickness of the cover layer 18 so that the top side of the cover layer 18 is flush with the upper surface 12 of the housing 10. Similar to the embodiments shown in FIG. 2A and FIG. 3B, the cover layer 18 forms a dust-proof seal around the scrolling area 40 and the sensor dimple 16 on the lower surface 14 is covered with a transparent window (not shown).

An embodiment of the cover layer 18 is made of an elastic material with a high resistance to wear and tear. Examples of the elastic material include, but are not limited to, natural rubber, synthetic rubber, synthetic resin having rubber elasticity. Examples of synthetic rubbers include, but are not limited to, nitrile, diene, and acrylic rubbers, as well as thermoplastic ploymers such as polyolefins, polyesters and fluorine-containing polymers. Examples of synthetic resins having rubber elasticity include, but are not limited to, ethylene/vinyl acetate copolymers, polyurethanes, polybutadiene, and flexible poly(vinyl chloride). Even polymers which are intrinsically rigid, such as poly (vinyl chloride), can be made to have rubber elasticity by incorporating a plasticizer, softener, or the like.

In one embodiment, the cover layer 18 is made of a high-strength, stretchable plastic. Examples of high-strength, stretchable plastics include, but are not limited to, polyethylene terephthalate (PET), polyester obtained by replacing the principal acid component or principal glycol component of PET (PET copolymer), a mixture of the preceding polymers, polyamide (12-nylon, 11-nylon, and MXD 6-nylon), and polyarylenesulfide such as PPS (polyphenylenesulfide).

Examples of acids that can be used to replace the principal acid component of PET include, but are not limited to, isophthalic acid, orthophthalic acid, naphthalenedicarboxylic acid, paraphenylenedicarboxylic acid, cyclohexanedicarboxylic acid, succinic acid, glutaric acid, adipic acid, suberic acid, azelaic acid, sebacic acid, dodecanedione acid, trimellitic acid, pyromellitic acid, sulfoisophthalic acid, and their salts.

Examples of glycols that can be used to replace the principal glycol component of PET include, but are not limited to, propylene glycol, butanediol, pentanediol, hexanediol, neopentyl glycol, diethylene glycol, trieihylene glycol, polyethylene glycol, polytetramethylene glycol, cyclohexanedimethanol, ethylene oxide-added bisphenol A, trimethylolpropane, and pentaerythritol.

In another embodiment, the cover layer 18 is made of a transparent material so that no window is needed for the optical sensor at the lower surface 14.

In yet another embodiment, the cover layer 18 comprises multiple sublayers. A multilayered structure takes advantage of different properties exhibited by the various sublayers in the structure. Typical of multilayered structures are multilayered films in which different layers have specific characteristics. For example, a multilayered structure may contain one or more polyester or polyolefin sublayers to provide mechanical strength and a fluoropolymer sublayer to provide an excellent moisture barrier property.

In one embodiment, the cover layer 18 is glued to the housing 10. In another embodiment, the cover layer 18 comprises a heat adhesive sublayer on its inner side and is attached to the housing 10 by heat press. The heat adhesive sublayer typically comprises a thermoplastic resin with a melting point at 60° C.-140° C. In one embodiment, the cover layer 18 may have a thickness ranging from 0.1-2 mm. In another embodiment, the cover layer 18 may have a thickness ranging from 0.2-1 mm. A thicker cover layer 18 provides better resistance to wear and tear. However, the cover layer 18 needs to be thin enough so that a user may depress the buttons 20 through the cover layer 18 and feel the “click” of the buttons 20.

In yet another embodiment, the dust-proof layer 18 is thicker in areas that arc subject to more wear and tear, such as the griping areas on both sides of the mouse 200 or 300 (i.e., the areas where the griping fingers hold the mouse), the areas above the buttons 20 where a linger click the buttons 20 through the cover layer 18, and the bottom surface of the mouse 200 or 300, where the cover layer 18 is constantly rubbed against a mouse pad or a hard surface.

Alternatively, the cover layer 18 may be reinforced at locations that are subject to more wear and tear with an additional layer or layers of high mechanical strength material, such as carbon fiber and nylon fiber (e.g., Kevlar®).

While the invention has been described in connection with what is presently considered to be the most practical and preferred embodiment, it is to be understood that the invention is not limited to the disclosed embodiments, but, on the contrary, is intended to accommodate various modifications and equivalent arrangements. It will be appreciated by those of ordinary skill in the art that a wide variety of alternate and/or equivalent embodiments or implementations calculated to achieve the same purposes may be substituted for the embodiments shown and described. This application is intended to cover any adaptations or variations of the embodiments discussed herein. Therefore, it is manifestly intended that embodiments in accordance with the present invention be limited only by the claims and the equivalents thereof.

What is claimed is:

1. A dust-proof computer mouse with scrolling function, comprising:
a housing comprising an upper surface and a lower surface;
at least one depressible button on said upper surface, wherein said housing and said depressible button define spaces around said depressible button;
a scrolling area on said upper surface;
an optical sensor dimple on said lower surface; and
a cover layer covering the spaces around said depressible button.

2. The computer mouse of claim 1, wherein said cover layer is sealed around said scrolling area.

3. The computer mouse of claim 2, wherein said scrolling area comprises a touchpad.

4. The computer mouse of claim 2, wherein said scrolling area comprises an optical finger navigator.

5. The computer mouse of claim 1, wherein said cover layer covers both the upper surface and the lower surface of said housing.

6. The computer mouse of claim 5, wherein said housing further comprises a touchpad on said upper surface and wherein said cover layer has a thickness that allow normal operation of said touchpad.

7. The computer mouse of claim 5, wherein said housing further comprises an optical finger navigator on said upper surface and wherein said cover layer has a transparency that allow normal operation of said optical finger navigator.

8. The computer mouse of claim 5, wherein said cover layer comprises a transparent window over said optical sensor dimple.

9. The computer mouse of claim 1, wherein said cover layer covers only the upper surface of said housing.

10. The computer mouse of claim 9, further comprising a transparent window covering said optical sensor dimple on said lower surface.

11. The computer mouse of claim 1, wherein said housing comprises an recessed area around said depressible button on said upper surface and wherein said cover layer is sized to fit into said recessed area and covers the spaces around said depressible button.

12. The computer mouse of claim 11, wherein said upper surface of said housing comprises scrolling area, and wherein said cover layer is sealed around said scrolling area.

13. The computer mouse of claim 1, wherein said cover layer comprises an elastic material.

14. The computer mouse of claim 13, wherein said elastic material is selected from a group consisting of natural rubber, synthetic rubber, and synthetic resin having rubber elasticity.

15. The computer mouse of claim 13, wherein said cover layer has a thickness in the range of 0.1-2 mm.

16. The computer mouse of claim 13, wherein said cover layer comprises multiple sublayers.

17. The computer mouse of claim 13, wherein said cover layer is reinforced in areas subject to more wear and tear.

18. The computer mouse of claim 17, wherein said cover layer is reinforced by increasing the thickness of said cover layer.

19. The computer mouse of claim 17, wherein said cover layer is reinforced by incorporating a material of high mechanical strength.

20. The computer mouse of claim 19, wherein said material of high mechanical strength includes carbon fibers and nylon fibers.
